(19) United States
(12) Patent Application Publication
(10) Pub. No.: US 2022/0221145 A1
(43) Pub. Date: Jul. 14, 2022

(54) ILLUMINATED HANDLEBAR GRIP

(71) Applicant: Shanon Dale Parker, Melbourne, FL (US)

(72) Inventor: Shanon Dale Parker, Melbourne, FL (US)

(21) Appl. No.: 17/647,916

(22) Filed: Jan. 13, 2022

Related U.S. Application Data
(60) Provisional application No. 63/199,616, filed on Jan. 13, 2021.

(51) Int. Cl. F21V 33/00; F21V 3/00; F21S 9/02

(52) U.S. Cl. CPC F21V 33/008; F21Y 2115/10; F21S 9/02; F21V 3/00

(57) ABSTRACT

An illuminated handlebar grip for improving visibility of a cyclist by other motor vehicle operators. The illuminated handlebar grip includes an outer cover made of a resilient grip material, an illumination diffuser element carried within the outer cover, a light source, and, preferably, an internal grip element adapted for attachment to a handlebar assembly of a vehicle. The outer cover has a plurality of cut outs extending through a surface of the cover to at least partially expose the illumination diffuser element carried therein. The light source may be an LED or an EL material. The light source may be powered by an electrical system of the cycle or by a battery source carried in the grip. The light source may be controlled to vary in intensity or be operable between a steady and a flash mode.

### CROSS-REFERENCE TO RELATED APPLICATION

This application claims the benefit of priority of U.S. provisional application No. 63/199,616 filed Jan. 13, 2021, the contents of which are herein incorporated by reference.

### BACKGROUND OF THE INVENTION

The present invention relates to grips for handles, and more particularly to handlebar grips for motor and occupant powered vehicles, such as motorcycles, bicycles, all terrain vehicles (ATVs), and the like.

Grips for handlebars have traditionally been designed for comfort, style, and control of the vehicle to which they are applied. However, little has been done in the way of improving the safety of the operator while driving or riding such vehicles.

Numerous accidents involving cycles, whether motorized or pedaled, are attributed to a motor vehicle operator not seeing the cyclist prior to the accident, the incidence of these accident are particularly prevalent during periods of reduced visibility, such as during hours of darkness or inclement weather conditions.

As can be seen, there is a need for improved handlebar grips that improve the safety of the operator, while providing comfort, control, and style.

### SUMMARY OF THE INVENTION

In one aspect of the present invention, an illuminated handle grip is disclosed. The illuminated handle grip includes a grip body having a generally cylindrical shape adapted to be positioned over an end of a handle control. An illumination diffuser element is disposed between the grip body and the handle control. The illumination diffuser element is adapted to communicate and disperse light emitted from a light source coupled with the illumination diffuser element. One or more recesses are defined in a surface of the grip body, the one or more recesses configured to emit the light carried by the illumination diffuser element.

In some embodiments, the illumination diffuser element is a generally cylindrical sleeve adapted to encircle the handle control; and the light source is a light ring having a light emitting face oriented to project light into an end of the generally cylindrical sleeve.

In some embodiments, the light source includes a first light ring and a second light ring disposed at opposed ends of the illumination diffuser element.

In some embodiments, an end cap is disposed at an end of the illuminated handle grip, the end cap operable to activate the light source. A battery can be carried within the end cap. The end cap may be operable to control an intensity of the light source.

In some embodiments, the one or more recesses define a cutout extending to expose a surface of the illumination diffuser element.

In other embodiments, the grip body is formed of a resilient material. The grip body may be formed of a translucent material.

In other aspects of the invention, an illuminated handle grip includes a resilient grip body having one or more cut outs circumferentially disposed about the resilient grip body. An illumination diffusing element is carried within the resilient grip body. A light source is in communication with the illumination diffusing element, such that a light emitted by the light source is communicated through the illumination diffusing element and is emitted from the illuminated handle grip via the one or more cutouts.

In some embodiments, the light source includes an LED light strip carried within a channel defined along a longitudinal length of the resilient grip body. The illumination diffusing element may be integrated with the LED light strip.

In some embodiments, the illumination diffusing element comprises a cylindrical translucent tube underlying the resilient grip body.

In some embodiments, the light source includes a light ring having a light emitting face oriented to project light into an end of the cylindrical translucent tube. The light source may include a first light ring and a second light ring disposed at opposed ends of the illumination diffuser element.

In other embodiments, an end cap is disposed at an end of the illuminated handle grip. The end cap is operable to activate the light source. A battery may also be carried within the end cap.

These and other features, aspects and advantages of the present invention will become better understood with reference to the following drawings, description and claims.

### BRIEF DESCRIPTION OF THE DRAWINGS

FIG. 1 is a front perspective view of an illuminated handgrip.

FIG. 2 are front perspective views of alternative embodiments of the illuminated handgrip.

FIG. 3 is a perspective view of the illuminated handgrip in an illuminated condition.

FIG. 4 is a front perspective view of the illuminated handgrip.

FIG. 5 is an exploded front perspective view of the illuminated handgrip and diffuser.

FIG. 6 is a partial sectional view of an embodiment of the illuminated handgrip with a light emitting diode (LED) light strip configuration.

FIG. 7 is an exploded partial sectional view of the embodiment of the illuminated handgrip of the LED light strip configuration.

FIG. 8 is a front elevation view of the illuminated handgrip.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides an illuminated handle bar grip. The illuminated handle grips may be utilized on any motorized or occupant propelled vehicle with a grip handle steering or control, such as a motorcycle, bicycle, four wheel all terrain vehicle (ATV), and the like.

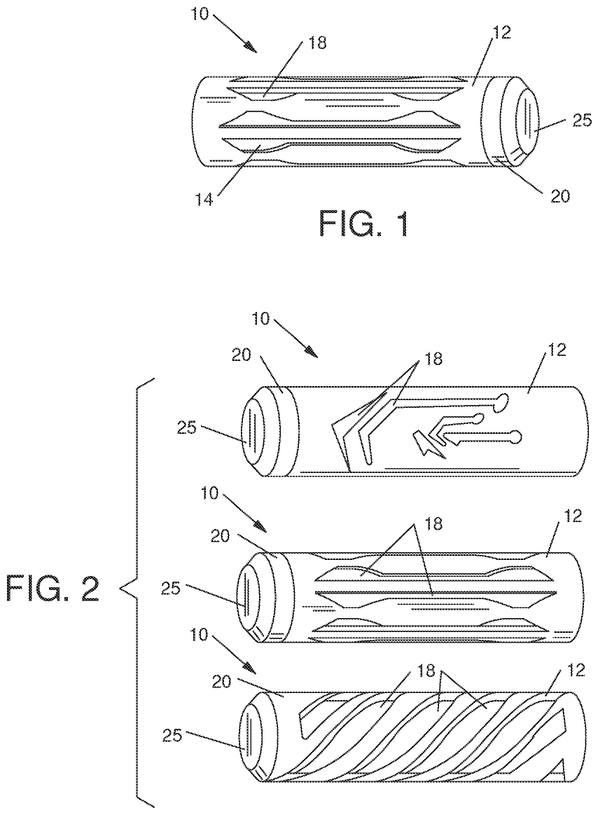

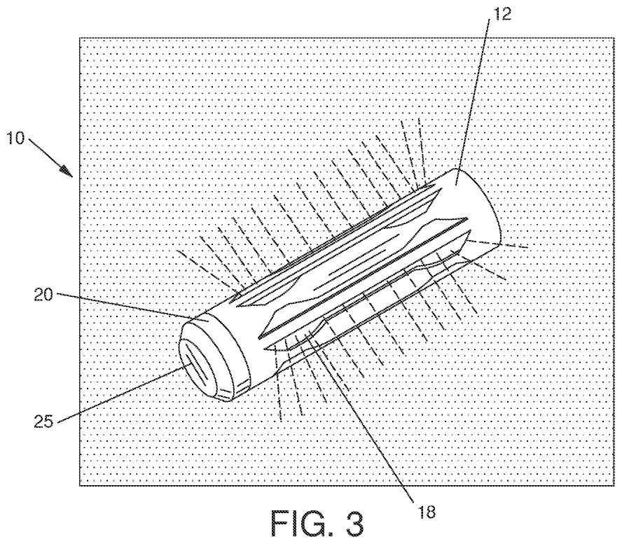

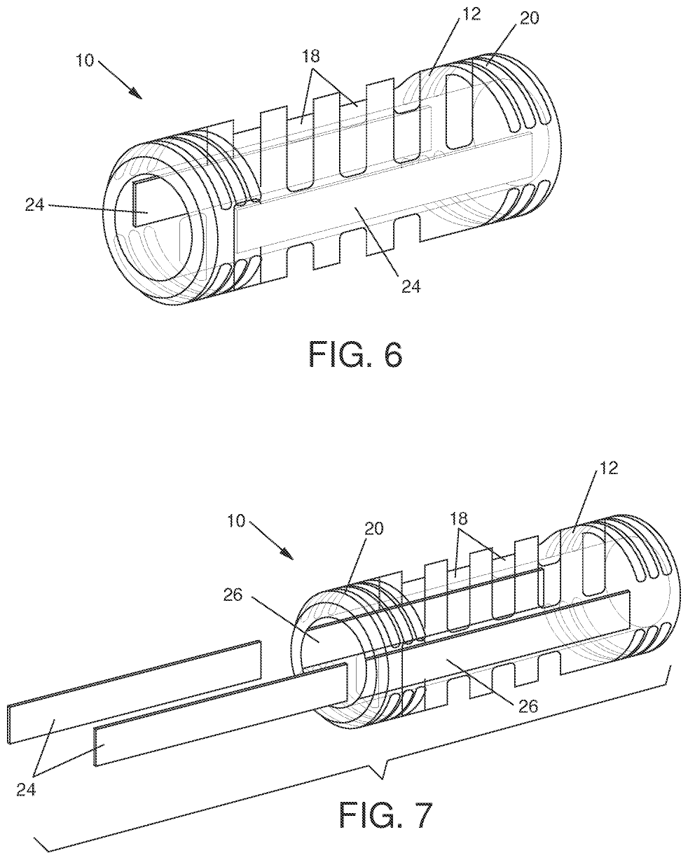

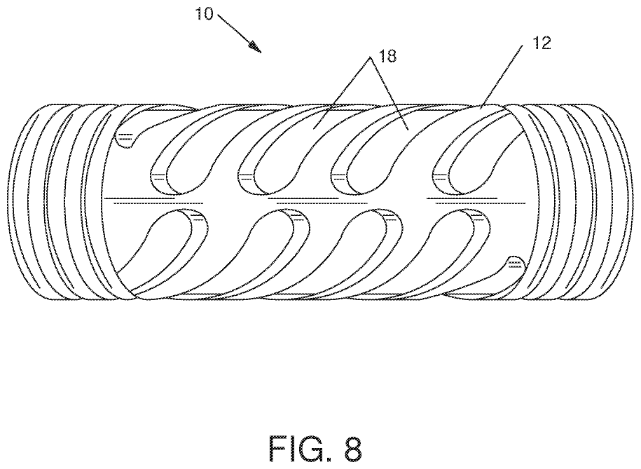

As seen in reference to the drawings of FIGS. 1-7, the illuminated handle grips 10 according to aspects of the invention includes a grip body 12 having an outer surface covering that is positioned over an illumination diffuser element 14. The illumination diffuser element 14 is be adapted to be positioned over an end of a handle bar, or a control handle 16 (partially shown for clarity of the drawings), and may have an internal sleeve 14 that is configured for the same. The illuminated handle grips 10 may be applied to the handle bar control 16 of the selected vehicle. The grip body 12 has outer surface covering may be formed of a soft resilient material, such as rubber, neoprene, or the like. The grip body 12 may be generally cylindrical and may have protrusions disposed along a longitudinal length to accommodate a user's fingers and hands for gripping.

The outer surface of the grip body 12 has a plurality of cut outs 18 that may extend therethrough to expose at least a portion of the illumination diffuser element 14. A light source, such as one or more light emitting diodes (LEDs), electro luminescent (EL) materials, or the like may be in communication with the illumination diffuser element 14 such that light emitted by the light source is communicated through the illumination diffuser element 14 to be emitted through the one or more cut outs 18 in the outer sleeve of the grip body 12. When a transparent or a translucent material is used for the grip body 12, the one or more cut outs 18 may be recesses that where a thinning of the grip body 12 in the recess transmits more light from the light source than the remainder of the grip body 12. The internal sleeve, when present, or handle bar control surface 16 may be provided with a reflective surface so as to reflect light into the illumination diffuser 24 to improve light transmission.

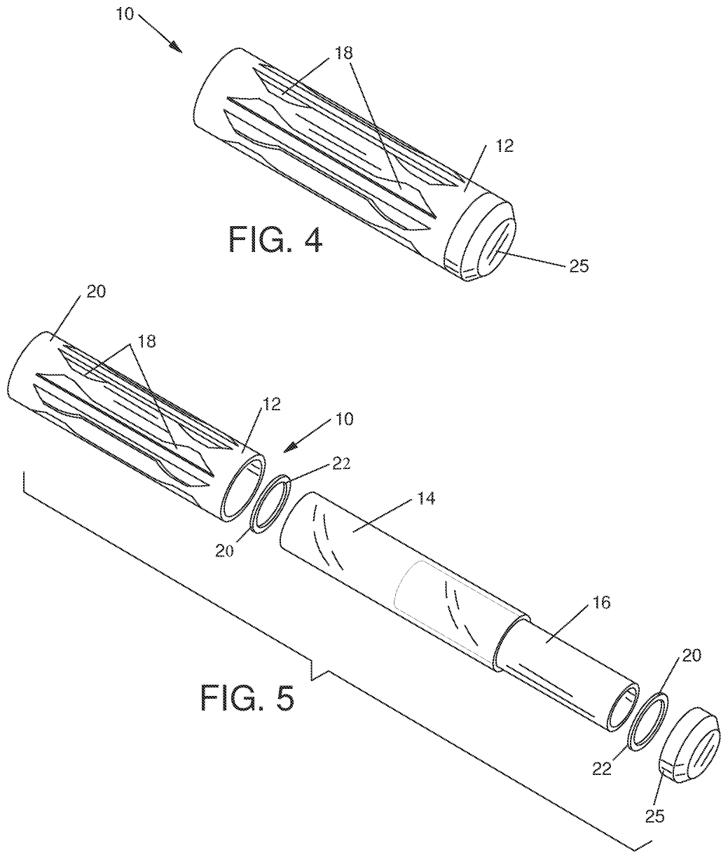

In a non-limiting example, such as shown in reference to FIGS. 4 and 5, the light source may be configured as a light ring 20 with the LED emissions oriented through an emitting face 22 of the ring. The emitting face 22 may be positioned in abutment with an end of the illumination diffuser element 14. In some embodiments, the light source may include a light ring 20 applied in abutment with one or more of an outer and an inner end of the illumination diffuser element 14. As will be appreciated from the present disclosure, the illumination diffuser element 14 may be formed of an optically conductive material, such as Plexiglas or an Acrylic material. The illumination diffuser element 14 may have a transparent or a frosted surface treatment depending on a desired lighting effect emitted from the one or more cut outs 18 of the illuminated handle grip 10.

In an alternative non-limiting embodiment shown in reference to FIGS. 5-7, the illumination source may be an LED lighting strip 24 that may be carried within one or more interior chambers 26 defined along a longitudinal length of the grip body 12 of the hand grip 10. The LED light strip 24 may include an integrated diffuser element which carries the light emissions from a plurality of LED lights in the LED light strip 24 to the plurality of cutouts in the outer surface of the hand grip.

The light source is electrically connected to a power source, which may be a battery or an alternator or generator carried by the vehicle. In some embodiments, an end cap 25 for the illuminated handle grip 10 may be utilized to house a battery and battery connection. The battery may be carried within the end cap 25, or an end of the battery may be attached to the end cap 25, with a remaining portion of the battery dimensioned to be received within a void in the handle control 16 to which the illuminated handle grip 10 is attached.

The illumination source may be controlled in conjunction with other lighting systems on the vehicle via electrical conductors. Alternatively, the light source may be controlled independently of other lighting systems, for example by rotation of the end cap 25 or activation of a switch carried in the illuminated handle grip 10. The control may allow for variation of the lighting intensity and it may be configured to select between a steady or a flashing mode. As will be appreciated, the color of the light source may be varied, depending upon the application, or an operational condition of the vehicle, such as to indicate a turn or a stop.

As stated above, the illuminated hand grips 10 of the present invention illuminate for safety and visual enhancement so that other motor vehicle operators can better see riders better when the illuminated handgrips 10 are illuminated.

It should be understood, of course, that the foregoing relates to exemplary embodiments of the invention and that modifications may be made without departing from the spirit and scope of the invention as set forth in the following claims.

What is claimed is:

1. An illuminated handle grip, comprising:
a grip body having a generally cylindrical shape adapted to be positioned over an end of a handle control;
an illumination diffuser element disposed between the grip body and the handle control, the illumination diffuser element adapted to communicate and disperse light emitted from a light source coupled with the illumination diffuser element; and
one or more recesses defined in a surface of the grip body, the one or more recesses configured to emit the light carried by the illumination diffuser element.

2. The illuminated handle grip of claim 1, wherein the illumination diffuser element is a generally cylindrical sleeve adapted to encircle the handle control; and the light source is a light ring having a light emitting face oriented to project light into an end of the generally cylindrical sleeve.

3. The illuminated handle grip of claim 2, wherein the light source includes a first light ring and a second light ring disposed at opposed ends of the illumination diffuser element.

4. The illuminated handle grip of claim 3, further comprising:
an end cap disposed at an end of the illuminated handle grip, the end cap operable to activate the light source.

5. The illuminated handle grip of claim 4, further comprising:
a battery carried within the end cap.

6. The illuminated handle grip of claim 4, wherein the end cap is operable to control and intensity of the light source.

7. The illuminated handle grip of claim 1, wherein the one or more recesses define a cutout extending to expose a surface of the illumination diffuser element.

8. The illuminated handle grip of claim 1, wherein the grip body is formed of a resilient material.

9. The illuminated handle grip of claim 1, wherein the grip body is formed of a translucent material.

10. An illuminated handle grip, comprising:
a resilient grip body having one or more cut outs circumferentially disposed about the resilient grip body;
an illumination diffusing element carried within the resilient grip body; and
a light source in communication with the illumination diffusing element, wherein a light emitted by the light source is communicated through the illumination diffusing element and is emitted from the illuminated handle grip via the one or more cutouts.

11. The illuminated handle grip of claim 10, wherein the light source includes an LED light strip carried within a channel defined along a longitudinal length of the resilient grip body.

12. The illuminated handle grip of claim 11, wherein the illumination diffusing element is integrated with the LED light strip.

13. The illuminated handle grip of claim 11, wherein the illumination diffusing element comprises a cylindrical translucent tube underlying the resilient grip body.

14. The illuminated handle grip of claim 13, wherein the light source comprises:
a light ring having a light emitting face oriented to project light into an end of the cylindrical translucent tube.

15. The illuminated handle grip of claim 13, wherein the light source comprises:
a first light ring and a second light ring disposed at opposed ends of the illumination diffuser element.

16. The illuminated handle grip of claim 14, further comprising:
an end cap disposed at an end of the illuminated handle grip, the end cap operable to activate the light source.

17. The illuminated handle grip of claim 16, further comprising:
a battery carried within the end cap.
